(19) United States
(12) Patent Application Publication
(10) Pub. No.: US 2024/0127001 A1
(43) Pub. Date: Apr. 18, 2024

(54) Audio Understanding with Fixed Language Models

(71) Applicant: International Business Machines Corporation, Armonk, NY (US)

(72) Inventors: Kaizhi Qian, Champaign, IL (US); Yang Zhang, Cambridge, MA (US); Chuang Gan, Cambridge, MA (US); Bo Wu, Cambridge, MA (US); Zhenfang Chen, Cambridge, MA (US)

(21) Appl. No.: 17/964,633

(22) Filed: Oct. 12, 2022

(51) Int. Cl. G06F 40/40; G10L 15/26

(52) U.S. Cl. CPC G06F 40/40; G10L 15/26

(57) ABSTRACT

Techniques for audio understanding using fixed language models are provided. In one aspect, a system for performing audio understanding tasks includes: a fixed text embedder for, on receipt of a prompt sequence having (e.g., from 0-10) demonstrations of an audio understanding task followed by a new question, converting the prompt sequence into text embeddings; a pretrained audio encoder for converting the prompt sequence into audio embeddings; and a fixed autoregressive language model for answering the new question using the text embeddings and the audio embeddings. A method for performing audio understanding tasks is also provided.

### STATEMENT REGARDING PRIOR DISCLOSURES BY THE INVENTOR OR A JOINT INVENTOR

The following disclosure(s) are submitted under 35 U.S.C. 102(b)(1)(A):

### Disclosure(s):

“WavPrompt: Towards Few-Shot Spoken Language Understanding with Frozen Language Models,” Heting Gao, Junrui Ni, Kaizhi Qian, Yang Zhang, Shiyu Chang, Mark Hasegawa-Johnson, arXiv:2203.15863v1 Mar. 29, 2022 (5 pages).
“WavPrompt: Towards Few-Shot Spoken Language Understanding with Frozen Language Models,” Heting Gao, Junrui Ni, Kaizhi Qian, Yang Zhang, Shiyu Chang, Mark Hasegawa-Johnson, arXiv:2203.15863v2 Apr. 14, 2022 (5 pages).

### FIELD OF THE INVENTION

The present invention relates to machine learning, and more particularly, to techniques for audio understanding using fixed language models.

### BACKGROUND OF THE INVENTION

Large-scale pretrained language models have brought great success in natural language processing. Natural language processing enables computers to process human language and understand its meaning. Recent research has discovered that pretrained language models also demonstrate a strong capability for few-shot learning on many natural language processing tasks. Few-shot learning deals with making predictions based on a limited number of samples.

In that regard, pretrained language models have been shown to perform new natural language tasks with only a few text examples, without the need for fine-tuning. For instance, if a prefix containing several text-prompt-answer demonstrations of a task are fed to a pretrained language model, as well as a new question, the pretrained language model can generate a decent answer to the new question upon seeing the prefix.

Few-shot learning using pretrained language models has also been extended to modalities other than text. For instance, by pretraining an image encoder to generate feature vectors that are meaningful to a pretrained language model, it has been shown that the pretrained language model can be given the ability to solve few-shot image understanding tasks. One such approach employs a neural network trained to encode images into the word embedding space of a large-pre-trained language model such that the language model generates captions for those images. The weights of the language model are kept constant or frozen. To date, however, no such capabilities exist for few-shot audio understanding.

Thus, techniques for transferring few-shot learning ability to the audio-text setting would be desirable.

### SUMMARY OF THE INVENTION

The present invention provides techniques for audio understanding using fixed language models. In one aspect of the invention, a system for performing audio understanding tasks is provided. The system includes: a fixed text embedder for, on receipt of a prompt sequence having (e.g., from 0-10) demonstrations of an audio understanding task followed by a new question, converting the prompt sequence into text embeddings; a pretrained audio encoder for converting the prompt sequence into audio embeddings; and a fixed autoregressive language model for answering the new question using the text embeddings and the audio embeddings.

In another aspect of the invention, a method for performing audio understanding tasks is provided. The method includes: pretraining an audio encoder using a fixed autoregressive language model and a fixed text embedder; receiving a prompt sequence having (e.g., from 0-10) demonstrations of an audio understanding task followed by a new question; converting the prompt sequence into embeddings using the audio encoder and the fixed text embedder; and answering the new question using the embeddings by the fixed autoregressive language model.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary method for performing audio understanding tasks according to an embodiment of the present invention;

FIG. 2 is a schematic diagram illustrating an exemplary convolutional neural network according to an embodiment of the present invention;

FIG. 3A is a diagram illustrating an exemplary architecture of the present audio understanding system during pretraining of the audio encoder according to an embodiment of the present invention;

FIG. 3B is a diagram illustrating an exemplary architecture of the present audio understanding system during inference according to an embodiment of the present invention;

FIG. 4A is a diagram illustrating performance of the present system on speech understanding tasks as compared to a baseline process with 5 hours of pretraining data according to an embodiment of the present invention;

FIG. 4B is a diagram illustrating performance of the present system on the speech understanding tasks as compared to the baseline process with 10 hours of pretraining data according to an embodiment of the present invention;

FIG. 4C is a diagram illustrating performance of the present system on the speech understanding tasks as compared to the baseline process with 100 hours of pretraining data according to an embodiment of the present invention;

FIG. 5 is a diagram illustrating classification accuracy across different downsampling rates according to an embodiment of the present invention;

FIG. 6 is a diagram illustrating classification accuracy between the present system with and without calibration according to an embodiment of the present invention;

FIG. 7A is a diagram illustrating classification accuracy versus number of shots across different datasets according to an embodiment of the present invention;

FIG. 7B is a diagram illustrating classification accuracy versus number of shots across different resource conditions according to an embodiment of the present invention;

FIG. 8 is a diagram illustrating classification accuracy across downsampling rates on a non-speech dataset according to an embodiment of the present invention; and

FIG. 9 is a diagram illustrating an exemplary computing environment according to an embodiment of the present invention.

### DETAILED DESCRIPTION OF PREFERRED EMBODIMENTS

Provided herein are techniques for extending few-shot learning capabilities to audio understanding tasks. The challenge in doing so centers on being able to directly understand speech without having to first transcribe it to text. However, in order to feed speech into a text-understanding system such as a pretrained language model, the speech has to be converted into something that the system understands.

More specifically, the present techniques involve performing a certain task such as speech and/or non-speech understanding given task demonstrations. The task demonstrations are in the form of triplets containing 1) an audio utterance, 2) a text question or prompt, and 3) a text answer. The term ‘audio’ as used herein refers to sound. Thus, an audio utterance generally refers to any vocal sound, whether it be a speech or non-speech utterance. Speech is a form of audio expression using articulate sounds. Text, on the other hand, refers to written or typed communications.

A new question can then be posed that is in a similar form to the task demonstrations but without an answer. The goal is to convert the task demonstrations and the new question into a text prefix and feed it to an autoregressive language model, so that the autoregressive language model can produce answers to the new question. For instance, an example will be provided below where the autoregressive language model is being taught to identify spoken commands in the audio utterance for interacting with a smart device by seeing a few short demonstrations, each containing three components: first, a speech utterance (saying, e.g., ‘play the song’), then a text prompt (‘the topic is’), and finally the text answer (‘song’). Concatenated to the end of the training demonstrations is a question in a similar form but without the answer. The fixed language model is judged to perform correctly if it generates the correct answer (e.g., either ‘song’ or ‘volume’). Examples will also be provided below involving non-speech audio understanding tasks such as those involving environmental sound classification to demonstrate that the present techniques can extract more information than just speech transcriptions.

As highlighted above, a main challenge of this task is to convert the speech into a form that can be accepted by the fixed language model as the text prefix. At first glance, one might be inclined to simply convert the speech to text using automatic speech recognition, and then perform few-shot learning on the transcribed demonstrations the same way as it is done in natural language processing tasks. However, such a paradigm would undesirably propagate the errors in automatic speech recognition to the fixed language model, thereby undermining its few-shot learning performance. Also, it is notable this solution could not handle non-speech audio understanding tasks.

Advantageously, the present techniques provide an end-to-end few-shot learning framework for speech or audio understanding tasks called WAVPROMPT. The WAVPROMPT framework includes an audio encoder and an autoregressive language model. An autoregressive model is a feed-forward model which predicts future values from past values. To look at it another way, an autoregressive model uses its previous predictions for generating new predictions. The audio encoder is pretrained as part of an automatic speech recognition system, so that it learns to convert the audio in text answer demonstrations into embeddings that are understandable to the autoregressive language model (i.e., a valid input that makes sense to the autoregressive language model—for example if the model only accepts numbers as input then characters would be considered invalid input). After pretraining, the entire framework is frozen and ready to perform few-shot learning upon seeing the demonstrations.

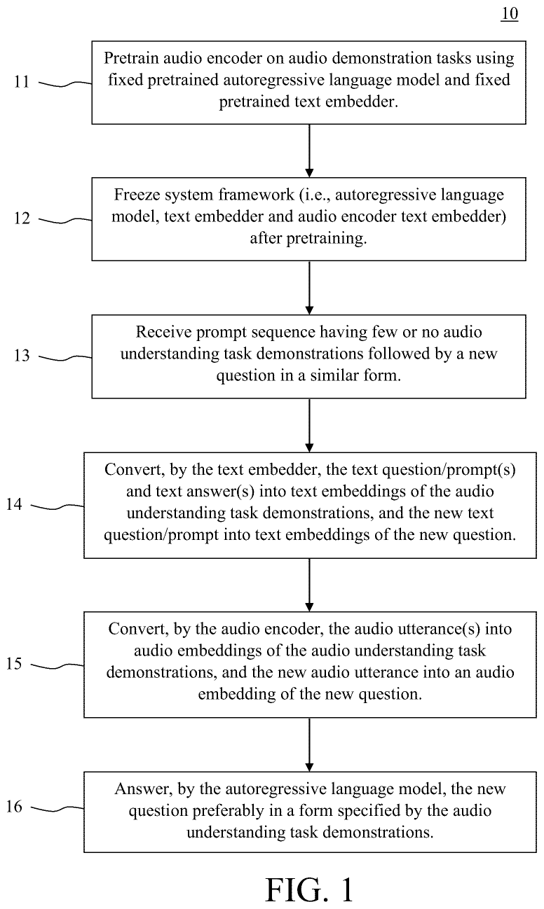

Given the above overview, an exemplary methodology 10 for performing audio understanding tasks in accordance with the present techniques is now described by way of reference to FIG. 1. In step 11, an audio encoder is pretrained on audio demonstration tasks using a fixed, pretrained autoregressive language model and a fixed, pretrained text embedder. Namely, the autoregressive language model and the text embedder are kept fixed, and only updates to the audio encoder are made during the pretraining in step 11. According to an exemplary embodiment, the autoregressive language model is a general-purpose learner containing the text embedder such as generative pre-trained Transformer 2 (GPT-2) which is a neural network machine learning model trained using internet data that translates text, answers questions, summarizes passages, and generates text output. By fixed, it is meant for example that the weights of the autoregressive language model are kept constant, i.e., fixed. However, as will be described in detail below, the gradients are backpropagated through the autoregressive language model in order to train the audio encoder from scratch.

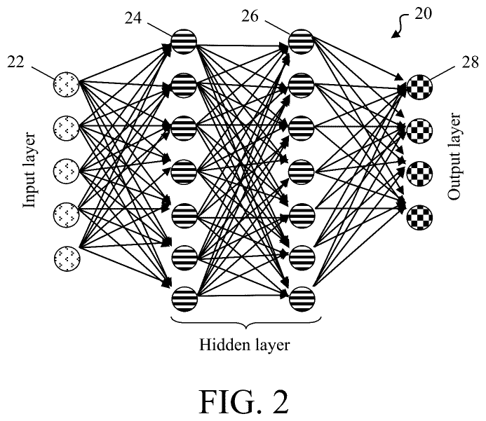

Referring briefly to FIG. 2, an exemplary neural network 20 is shown that includes a plurality of interconnected processor elements 22, 24/26 and 28 that form an input layer, at least one hidden layer, and an output layer, respectively, of the neural network 20. In machine learning and cognitive science, neural networks are a family of statistical learning models inspired by the biological neural networks of animals, and in particular the brain. Neural networks may be used to estimate or approximate systems and cognitive functions that depend on a large number of inputs and weights of the connections which are generally unknown. Neural networks are often embodied as so-called “neuromorphic” systems of interconnected processor elements which act as simulated “neurons” that exchange “messages” between each other in the form of electronic signals. The connections in neural networks that carry electronic messages between simulated neurons are provided with numeric weights that correspond to the strength or weakness of a given connection. These numeric weights can be adjusted and tuned based on experience, making neural networks adaptive to inputs and capable of learning. A neural network can be trained with an incremental or stochastic gradient descent (SGD) process, in which the error gradient of each parameter (weight) is calculated using backpropagation. Typically, neural networks are trained on labeled sets of training data. Once trained, the neural network can be used for inference. Inference applies knowledge from a trained neural network model and uses it to infer a result.

In one exemplary embodiment, the audio encoder is trained as part of an automatic speech recognition system with the goal being that the audio encoder learns to convert speech or non-speech audio utterances in the audio demonstration tasks into embeddings digestible by the autoregressive language model. As highlighted above, the audio understanding task demonstration are each in the form of a triplet containing an audio utterance, a text question/prompt, and a text answer. For instance, an example will be provided below where the question ‘what did the speaker say?’ is used as a prompt during pretraining. The output from the autoregressive language model must then match the audio utterance of the speaker, e.g., ‘to catch a glimpse of the expected train.’

According to an exemplary embodiment, the audio encoder is a multi-layer convolutional neural network such as the wav2vec 2.0 base model which encodes raw audio data, and then masks spans of the resulting latent representations. The latent representations are fed to a Transformer network to build contextualized representations. Convolutional neural networks are a class of neural networks. Convolutional layers are the main building blocks of a convolutional neural network. Each convolutional layer processes input through a set of filters (or kernels) which applies a convolution operation to the input, producing a feature map for each of the filters that maps the relevant features preserved by the filters. The results are then passed to the next layer in the convolutional neural network, and so on. Pooling is used to merge the data from the feature maps at each of the convolutional layers, and flattening is used to convert this data into a one-dimensional array that is then provided to a final fully-connected layer of the network which makes classification decisions.

Following pretraining of the audio encoder, the entire framework of the present system, namely the autoregressive language model, the text embedder and the audio encoder, is frozen. See step 12. The term ‘frozen’ as used herein refers to keeping one or more parameters of the autoregressive language model, the text embedder and the audio encoder constant/fixed. For instance, according to an exemplary embodiment, in step 12 the weights of the (now pretrained) audio encoder as well as the weights of the (fixed) autoregressive language model and text embedder are kept constant, and will remain so through the remainder of the process (including while performing audio understanding tasks on a new question(s)).

The system with its (now fixed) pretrained audio encoder can then be used for performing audio understanding tasks. For instance, in step 13 a prompt sequence is received that contains few audio understanding task demonstrations (few-shot) or no audio understanding task demonstrations (zero-shot) of a new task. Again, each of these audio understanding task demonstrations is in the form of a triplet containing an audio utterance, a text question/prompt and a text answer. Here, however, the audio understanding task demonstration(s) is/are followed by a new question that is in a similar form (i.e., the new question contains a new audio utterance and new text question/prompt), but without a new answer—and the system is tasked with answering the question/prompt in the form specified in the task demonstrations. For instance, by way of example only, the new question can be a sentence with a gap at the end, e.g., ‘The speaker is describing [gap].’ The pretrained autoregressive language model must then fill in the gap based on the content of the new audio utterance, thereby effectively extracting meaning from audio. As highlighted above, the present system is broadly applicable to performing audio understanding tasks involving both speech and non-speech audio utterances.

According to an exemplary embodiment, the system is employed as a few-shot learner, and in step 13 is given a prompt sequence containing 10 or less of the audio understanding task demonstrations. Alternatively, the system can also be employed as a zero-shot learner. For instance, embodiments are contemplated herein where the prompt sequence contains from 0 to 10 audio understanding task demonstrations, where in the case of 0 it is meant that the prompt sequence contains no audio understanding task demonstrations, just the new question.

The next task is to convert the prompt sequence (i.e., the audio understanding task demonstrations (if any) and the new question) into embeddings that can be fed to the autoregressive language model. This conversion is done via the pretrained text embedder and audio encoder. Namely, in step 14, the text embedder converts the text question/prompt(s) and the text answer(s) into text embeddings of the audio understanding task demonstrations (if any), and converts the new text question/prompt into a text embedding of the new question. In step 15, the audio encoder converts the audio utterance(s) into audio embeddings of the audio understanding task demonstrations (if any), and converts the new audio utterance into an audio embedding of the new question.

The embeddings from step 14 and step 15 are provided to the autoregressive language model which, in step 16, is used to answer the new question. According to an exemplary embodiment, the autoregressive language model has to answer the question using the form specified in the audio understanding task demonstrations, assuming that at least one audio understanding task demonstration is included in the prompt sequence. Namely, using the above example, the audio understanding task demonstrations are in the form of a triplet that includes an audio utterance, a text question/prompt and a text answer. The new question similarly contains a new audio utterance and new text question/prompt, but no new answer. In that case, the autoregressive language model would be tasked with providing a text answer. For example, based on the content of a new audio utterance, ‘Increase the volume,’ and given the new text question/prompt, ‘The speaker is describing [gap],’ the autoregressive language model could provide the text answer ‘volume.’

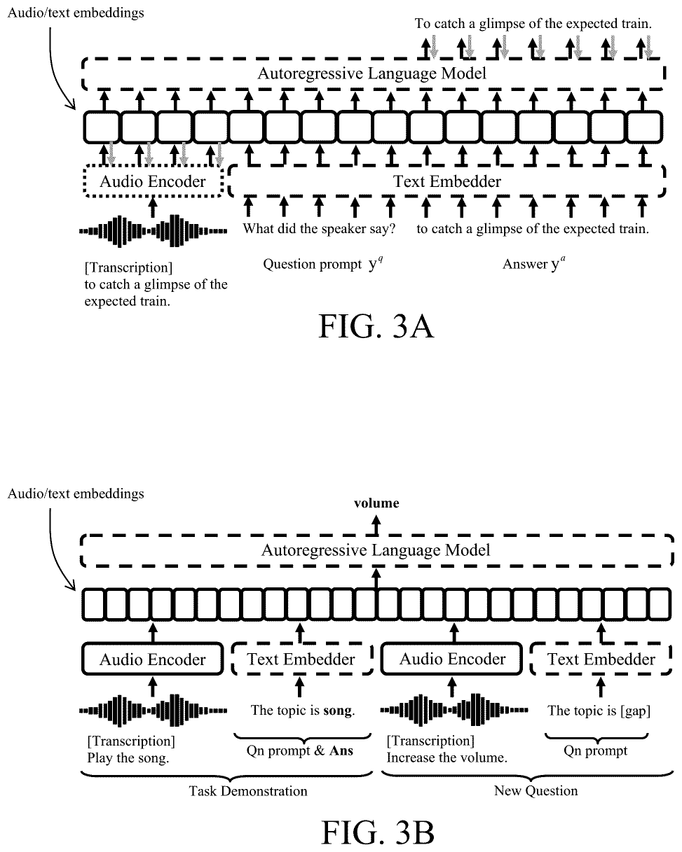

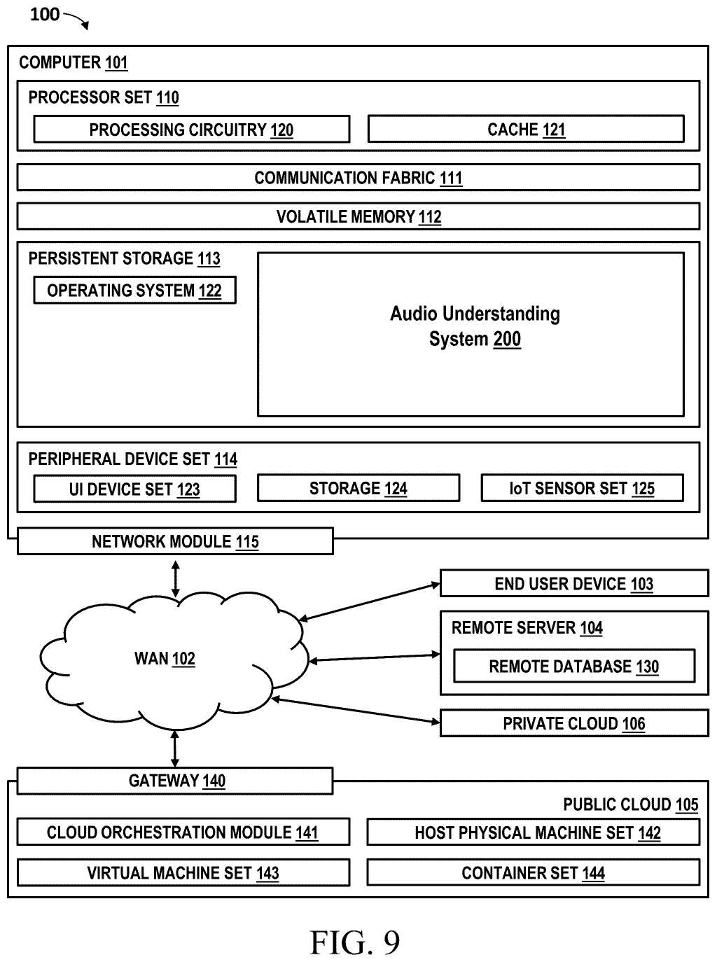

An exemplary architecture of the present audio understanding system is shown in FIG. 3A (during pretraining of the audio encoder) and in FIG. 3B (during inference). These exemplary audio understanding architectures may be implemented in the audio understanding system 200 of a computing environment such as that described, for example, in conjunction with the description of FIG. 9, below. As highlighted above, the present audio understanding system includes an autoregressive language model having a text embedder (labeled “Autoregressive language model” and “Text Embedder,” respectively) such as the generative pre-trained Transformer 2 model, and an audio encoder (labeled “Audio Encoder”) such as the wav2vec 2.0 model that is pretrained to convert audio utterances into embeddings understandable by the autoregressive language model.

For instance, according to an exemplary embodiment, the audio encoder f_{ϕ} encodes the speech audio x into continuous audio embeddings s=[s₁, s₂, . . . sₘ]=f_{ϕ}(x). The autoregressive language model contains a text embedder h_{θ} that converts the text y=[y₁, y₂, . . . , yₗ] into a sequence of text embeddings t=[t₁, t₂, . . . , tₙ]=h_{θ}(y) and a transformer-based neural network g_{θ} that models the text distribution p(y) as:

$$\\ log p ( y ) = {\sum }_{i = 1}^{n} log p ( {t}_{i} \vert {t}_{1} , … , {t}_{i - 1} ) = {\sum }_{i = 1}^{n} {{g}_{θ} ( {t}_{1} , … , {t}_{i - 1} )}_{{t}_{i}} .$$

With the above-described system framework, the audio embeddings and text embeddings may be generated at different rates by the audio encoder and the text embedder, respectively. For instance, the text embedder in the generative pre-trained Transformer 2 model generates text embeddings at only a fraction of the rate of the audio embeddings produced by the wav2vec 2.0 model. Thus, embodiments are contemplated herein where an (optional) downsampling layer is appended after the audio encoder to reduce the rate of audio embeddings so that the rate of the audio embedding can better match that of the text embeddings. Generally, downsampling involves skipping one or more samples of a time series.

As highlighted above, during a training phase, the audio encoder is pretrained. According to an exemplary embodiment, the audio encoder is pretrained as part of an automatic speech recognition system using publicly available datasets, so that the audio encoder learns to convert the audio utterances in the audio understanding task demonstrations (e.g., in the form of triplets including an audio utterance, a text prompt and a text answer) into embeddings that are digestible to the autoregressive language model. Specifically, referring to FIG. 3A, the text embedder and the autoregressive language model are kept fixed and only the audio encoder is updated during pretraining. By fixed, it is meant for example that the weights of the autoregressive language model are kept constant, i.e., fixed. As shown by the grey arrows in FIG. 3A, updates to the audio encoder are made by backpropagating the gradients through the autoregressive language model.

During the pretraining, the audio embeddings s, together with the text embeddings t^{q}=[t₁^{q}, t₂^{q}, . . . , tₙ^{q}] of the question prompt y^{q} are fed to the autoregressive language model so that the autoregressive language model models the probability of the answer y^{a} conditioned on the audio and the question prompt as:

$$\\ log p ( {y}^{{}^{} a} \vert x , {y}^{{}^{} q} ) = {\sum }_{i = 1}^{l} p ( {t}_{i}^{{}^{} a} \vert s , {t}^{{}^{} q} , {t}_{1}^{{}^{} a} , … , , {t}_{i - 1}^{{}^{} a} ) = {\sum }_{i = 1}^{l} {{g}_{θ} ( {s}_{1} , … , {s}_{m} , {t}_{1}^{{}^{} q} , … , {t}_{n}^{{}^{} q} , {t}_{1}^{{}^{} a} , … , {t}_{i - 1}^{{}^{} a} )}_{{t}_{i}^{{}^{} a}} .$$

In the illustrative, non-limiting example shown in FIG. 3A, the question ‘what did the speaker say?’ is used as a prompt during pretraining. In that case, the output from the autoregressive language model must then match the audio utterance of the speaker, e.g., ‘to catch a glimpse of the expected train’ in order to validate the training of the audio encoder. A transcription of the audio utterance is provided in FIG. 3A merely to provide the reader with the content of the utterance. Once the audio encoder is pretrained, the entire system framework is frozen. This means that the parameters (i.e., weights) of the fixed autoregressive language model, the fixed text embedder, and the audio encoder are all kept constant following the pretraining.

As highlighted above, the present system is a few-shot or even zero-shot learner where audio understanding tasks can be performed given few, if any, audio understanding task demonstrations. Namely, referring to FIG. 3B, during inference the fixed autoregressive language model is given a single prompt sequence that contains, for example, from 0 (zero-shot) to 10 (few-shot) demonstrations of a new audio understanding task (see ‘Task Demonstration’ in FIG. 3B), followed by a new question (see ‘New Question’ in FIG. 3B) that it must answer using the form specified in the demonstrations. As provided above, according to an exemplary embodiment the present audio understanding task demonstration(s) is/are in the form of triplets including an audio utterance, a text prompt and a text answer. For instance, in the non-limiting example shown in FIG. 3B, an audio understanding task demonstration might contain an audio (in this case speech) utterance by a speaker: ‘Play the song,’ a text prompt: ‘The topic is’ and a text answer: ‘song.’ Transcriptions of the audio utterances by the speaker are provided in FIG. 3B merely to provide the reader with the content of the utterances.

Using the same form as the demonstrations, the new question can include a (new) audio utterance and a (new) text prompt, but will be missing a (new) text answer. It is the job of the autoregressive language model to provide the missing new text answer. For instance, as shown in FIG. 3B, the new question can be a sentence with a gap at the end, such as ‘The speaker is describing [gap].’ Based on the content of the new audio utterance, i.e., ‘increase the volume,’ the autoregressive language model is tasked with filling in the gap. To do so, the (pretrained) audio encoder converts the audio utterance into audio embeddings of the audio understanding task demonstrations, if any, in the prompt sequence, and the new audio utterance into an audio embedding of the new question. The text embedder converts the text prompt and the text answer into text embeddings of the demonstrations, if any, in the prompt sequence, and the new text prompt into a text embedding of the new question. It is notable that, while FIG. 3B shows multiple instances of the audio encoder and text embedder, this is done merely to illustrate that the (single) audio encoder and the (single) text embedder each performs multiple operations. These audio and text embeddings are then provided to the autoregressive language model which produces the new text answer. See FIG. 3B. In one exemplary embodiment, each inference task is restricted to a finite output space, so that the accuracy of the present system can be meaningfully compared to chance performance. For instance, if an inference task has n answers, then the output space is limited to n.

Optionally, prior to inference, the autoregressive language model can be calibrated to maximize its performance using, for example, content-free input. Notably, the calibration does not need to change the (fixed) parameters of the autoregressive language model. For instance, the output distribution of the content-free input can be used to calibrate the output distribution of the normal input.

The present techniques are further described by way of reference to the following non-limiting examples. Performance of the present system was evaluated using several different speech and non-speech datasets. For instance, one dataset (Dataset A) contained approximately 600,000 spoken captions describing images classified using 12 super-category labels. These labels were used as the labels of the spoken captions. During evaluation, the present autoregressive language model was asked to discern between the ‘vehicle’ labels and the rest of labels, forming a total of 11 classification tasks. The question prompt ‘The speaker is describing’ was used.

Another dataset (Dataset B) contained spoken commands that interact with smart devices, such as ‘play the song’ and ‘increase the volume.’ Each command is labeled with action, object and location. Topic labels were defined to be the same as the object label most of the time, except that when the action was ‘change language,’ the topic was set to ‘language’ instead of the actual language name. The question prompt ‘The topic is’ was used.

Yet another dataset (Dataset C), also a dataset for spoken language understanding, contained human interaction with electronic home assistants from 18 different domains. Five domains were selected: ‘music’, ‘weather’, ‘news’, ‘email’ and ‘play,’ and ten domain pairs were formed for the present autoregressive language model to perform binary classification. The question prompt ‘This is a scenario of’ was used.

Still yet another dataset (Dataset D), contained 2000 environmental audio recordings including animal sounds, human non-speech sounds, natural soundscapes, domestic and urban noises, etc. The sound label was used as text, and the present autoregressive language model was pretrained on datasets for automatic speech recognition and environment sound classification tasks simultaneously. During pretraining of the audio encoder, the autoregressive language model was prompted with ‘What did the speaker say?’ for the automatic speech recognition task and ‘What sound is this?’ for the environment sound classification task. The autoregressive language model was tested on a subset of the training set that only contained sounds of animals, e.g., dog, cat, bird, etc. During testing, a distinct verb was assigned to each of the animal sounds: barks, meows, chirps, etc. The present system was tasked with predicting the correct verb given the animal sound and a few demonstrations. The question prompt was used during evaluation.

For speech classification tasks, the present autoregressive language model was pretrained with five downsampling rates (2, 4, 8, 16, 32) under three resource conditions (5, 10 and 100 hours of speech data). For non-speech classification tasks, the present autoregressive language model was pretrained with five downsampling rates (2, 4, 8, 16, 32) using 100 hours of speech data. During evaluation, several samples were randomly sampled along with their correct labels from the test set as shots. The shots were converted to embeddings and were prepended to the question prompt embeddings. 250 samples were sampled from the rest of the test set to form an evaluation batch. Samples were dropped from the class containing more samples to evenly balance the class labels in the batch. As a result, a binary classification accuracy greater than 50% is better than chance. Five batches were sampled with different random seeds. The classification accuracy is the average accuracy over the five batches.

The present system (WavPrompt) was compared with a baseline approach which converts speech into text and performs few-shot learning using the transcribed text. Specifically, the baseline approach used the same autoregressive language model. It performed few-shot learning via two steps. First, the speech was converted into text using an automatic speech recognition system. To achieve this, the present pretrained system was used as an automatic speech recognition system by prompting the autoregressive language model with the audio embedding and the pretraining question ‘what did the speaker say?’. Second, to perform few-shot learning, the autoregressive language model was prompted with the transcribed text embeddings instead of audio embeddings. In other words, the only difference between the present system and the baseline process was that the audio embeddings were used in the prompt in the former, whereas the transcribed text embeddings were used in the latter.

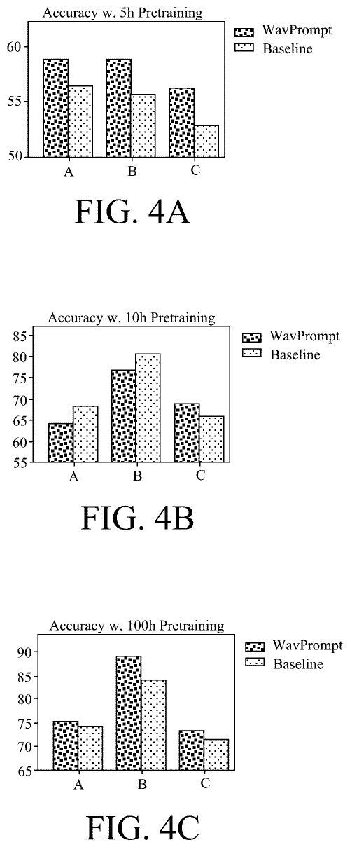

FIGS. 4A-C show the results on the speech understanding tasks (Dataset A, Dataset B and Dataset C). To factor out the influence of numbers of shots, the best accuracy achieved over all numbers of shots was used to represent the model's performance on individual pairs of labels, for both WavPrompt and the baseline approach. The average accuracy over all label pairs in a dataset was taken as the overall accuracy. The best-calibrated model among all the downsampling rates for both WavPrompt and the baseline approach was selected to make a fair comparison. The overall accuracy of the model across the speech understanding datasets was computed under the three resource conditions, i.e., 5 hours of pretraining data (FIG. 4A), 10 hours of pretraining data (FIG. 4B) and 100 hours of pretraining data (FIG. 4C).

As shown in FIG. 4A-C, both approaches (WavPrompt and baseline) can achieve an accuracy significantly above chance, which confirms that language models can perform zero-shot learning on speech understanding tasks. Also, the performance increases as the pretraining dataset size increases. Finally, WavPrompt consistently outperforms the baseline approach in nearly all cases across datasets and across resource conditions, which verifies the advantage of training an end-to-end framework. End-to-end training means that the model learns all of the steps between the input phase and the final output.

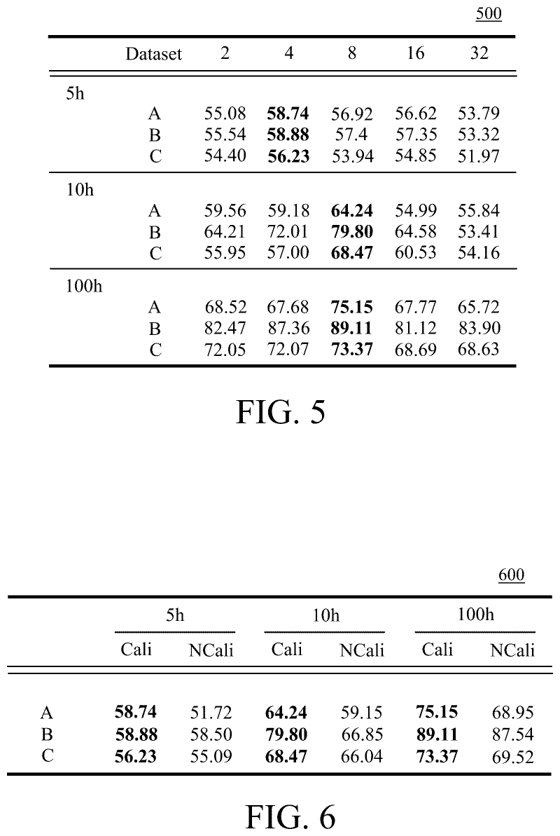

Ablation studies were also conducted. Regarding downsampling rate, as above, the best accuracy overall numbers of shots were used to represent the model performance. The best accuracy was averaged over all pairs of labels in each dataset. See FIG. 5. FIG. 5 is a diagram illustrating classification accuracy of the present system across different downsampling rates, 2, 4, 8, 16 and 32. The results shown in table 500 of FIG. 5 are consistent across datasets (Dataset A, Dataset B and Dataset C, see above), suggesting that a downsampling rate of 8 gives the best accuracy when the model is pretrained using 10 or more hours of data, and a downsampling rate of 4 gives better accuracy when the model is trained using 5 hours of data. The best downsampling rate being 8 was expected as it produces the audio embeddings at a rate closest to that of the text embeddings as described above.

Regarding calibration, the classification accuracy with calibration versus without calibration was compared using the best downsampling rate obtained in table 500. For each dataset, the best classification accuracy was averaged over all label pairs for both the model with calibration (‘Cali’) and without calibration (‘NCali’). The results are presented in table 600 of FIG. 6. In almost every case, the model with calibration outperforms that without calibration by a large margin, suggesting the necessity of calibrating the language model.

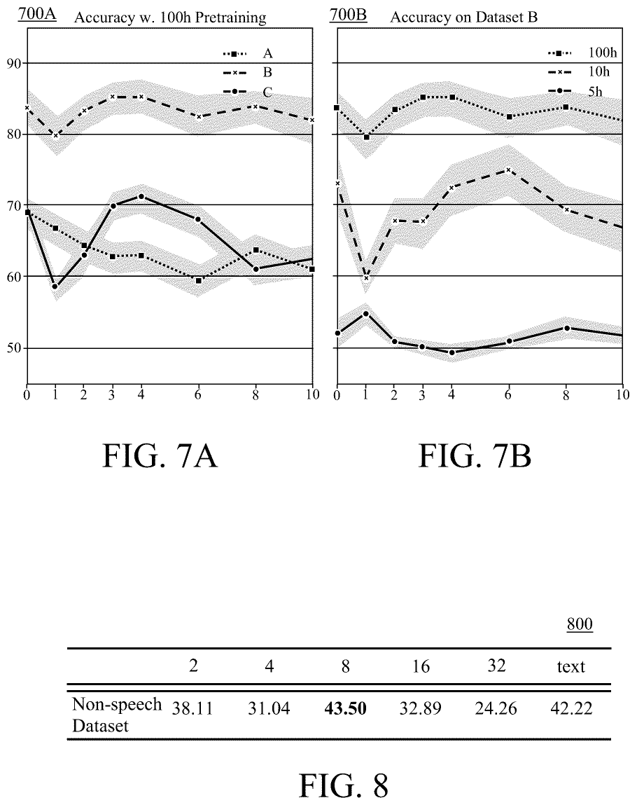

To study the effect of the number of shots, the classification accuracy is plotted across different datasets in plot 700A of FIG. 7A and the accuracy across different resource conditions on dataset B is plotted in plot 700B of FIG. 7B. The shaded regions are ±1 standard deviation. Although the accuracy curves exhibit different patterns across different datasets and different resource conditions, it was observed that there usually exist two peaks: one with zero demonstration examples, one with four to six demonstrations. In Dataset A experiments, zero-shot gives the best performance and increasing number of shots does not bring any benefits. One possible explanation is that the Dataset A is simpler than Datasets B and C, in the sense that the class labels or their near synonyms occur directly in the speech. Since the model has been pretrained as an automatic speech recognition system, the neurosymbolic representations of these answers may be already activated in the language model, so that the extra activation provided by the question is sufficient to generate a correct answer, even with zero demonstration examples. In Datasets B and C experiments, increasing shots to four or six yielded the best accuracy but further increasing shots downgraded the performance.

Regarding generalizing to non-speech tasks, a classification experiment was conducted using a non-speech dataset. Prompted with a few examples, WavPrompt needed to predict the correct verb corresponding to the animal that makes the non-speech sound. A text baseline was also provided that replaces audio embedding with the text embedding of the name of the animal. As above, the best accuracy across number of shots (i.e., task demonstrations) was used to represent the performance of the model, for both WavPrompt and the baseline approach. The results are shown in table 800 of FIG. 8. Specifically, table 800 in FIG. 8 displays classification accuracy across downsampling rates (i.e., downsampling rates 2, 4, 8, 16 and 32) on the non-speech dataset. It was observed that the classification accuracies are all better than chance, which is 11:11% for a nine-way classification, and the best performing WavPrompt with a downsampling rate of 8 was slightly better than the text baseline. These results show that WavPrompt is able to extract information from non-speech audio and then leverage commonsense knowledge from its pretrained language model to solve problems.

As will be described below, the present techniques can optionally be provided as a service in a cloud environment. For instance, by way of example only, one or more steps of methodology 10 of FIG. 1 can be performed on a dedicated cloud server.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 9, computing environment 100 contains an example of an environment for the execution of at least some of the computer code involved in performing the inventive methods, such as audio understanding system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 9. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A system for performing audio understanding tasks, the system comprising:
a fixed text embedder for, on receipt of a prompt sequence comprising demonstrations of an audio understanding task followed by a new question, converting the prompt sequence into text embeddings;
a pretrained audio encoder for converting the prompt sequence into audio embeddings; and
a fixed autoregressive language model for answering the new question using the text embeddings and the audio embeddings.

2. The system of claim 1, wherein the fixed autoregressive language model answers the new question in a form specified in the demonstrations.

3. The system of claim 2, wherein the demonstrations are in the form of triplets comprising:
an audio utterance;
a text prompt; and
a text answer.

4. The system of claim 3, wherein the audio utterance comprises speech.

5. The system of claim 3, wherein the audio utterance comprises non-speech.

6. The system of claim 3, wherein the new question comprises:
a new audio utterance; and
a new text prompt, and wherein the new question is missing a new text answer.

7. The system of claim 6, wherein the fixed text embedder converts the text prompt and the text answer into text embeddings of the demonstrations, and the new text prompt into a text embedding of the new question which are provided to the fixed autoregressive language model, and wherein the pretrained audio encoder converts the audio utterance into audio embeddings of the demonstrations, and the new audio utterance into an audio embedding of the new question which are provided to the fixed autoregressive language model.

8. The system of claim 7, wherein the fixed autoregressive language model fills in a gap at an end of a sentence based on a content of the new audio utterance.

9. The system of claim 1, wherein the prompt sequence comprises 10 or less of the demonstrations.

10. The system of claim 1, wherein the prompt sequence comprises from 0 to 10 of the demonstrations.

11. A method for performing audio understanding tasks, the method comprising:
pretraining an audio encoder using a fixed autoregressive language model and a fixed text embedder;
receiving a prompt sequence comprising demonstrations of an audio understanding task followed by a new question;
converting the prompt sequence into embeddings using the audio encoder and the fixed text embedder; and
answering the new question using the embeddings by the fixed autoregressive language model.

12. The method of claim 11, further comprising:
keeping weights of the fixed autoregressive language model, the fixed text embedder, and the audio encoder constant following the pretraining.

13. The method of claim 11, wherein the new question is answered using a form specified in the demonstrations, and wherein the demonstrations are in the form of triplets comprising:
an audio utterance;
a text prompt; and
a text answer.

14. The method of claim 13, wherein the audio utterance comprises speech.

15. The method of claim 13, wherein the audio utterance comprises non-speech.

16. The method of claim 13, wherein the new question comprises:
a new audio utterance; and
a new text prompt, and wherein the new question is missing a new text answer.

17. The method of claim 16, further comprising:
converting the text prompt and the text answer into text embeddings of the demonstrations, and the new text prompt into a text embedding of the new question; and
converting the audio utterance into audio embeddings of the demonstrations, and the new audio utterance into an audio embedding of the new question;
providing the text embeddings of the demonstrations, the text embedding of the new question, the audio embeddings of the demonstrations, and the audio embedding of the new question to the fixed autoregressive language model.

18. The method of claim 11, wherein the prompt sequence comprises from 0 to 10 of the demonstrations.

19. A computer program product for performing audio understanding tasks, the computer program product comprising a computer readable storage medium having program instructions embodied therewith, the program instructions executable by a computer to cause the computer to perform:
pretraining an audio encoder using a fixed autoregressive language model and a fixed text embedder;
receiving a prompt sequence comprising demonstrations of an audio understanding task followed by a new question;
converting the prompt sequence into embeddings using the audio encoder and the fixed text embedder; and
answering the new question using the embeddings by the fixed autoregressive language model.

20. The computer program product of claim 19, wherein the demonstrations are in a form of triplets comprising an audio utterance, a text prompt, and a text answer, wherein the new question comprises a new audio utterance, and a new text prompt, and wherein the program instructions further cause the computer to perform:
converting the text prompt and the text answer into text embeddings of the demonstrations, and the new text prompt into a text embedding of the new question; and
converting the audio utterance into audio embeddings of the demonstrations, and the new audio utterance into an audio embedding of the new question;
providing the text embeddings of the demonstrations, the text embedding of the new question, the audio embeddings of the demonstrations, and the audio embedding of the new question to the fixed autoregressive language model.
